(19) United States
(12) Patent Application Publication
(10) Pub. No.: US 2011/0037543 A1
(43) Pub. Date: Feb. 17, 2011

(54) ELECTRICAL SWITCHING DEVICE

(76) Inventor: Dale Walter Lange, Edmonds, WA (US)

Correspondence Address: Patent Docket Department;Armstrong Teasdale LLP, 7700 Forsyth Boulevard, Suite 1800, St. Louis, MO, 63105, US

(21) Appl. No.: 12/853,448

(22) Filed: Aug. 10, 2010

Related U.S. Application Data
(63) Continuation-in-part of application No. 11/870,971, filed on Oct. 11, 2007, now Pat. No. 7,772,945.

(51) Int. Cl. H01H 9/00

(52) U.S. Cl. 335/127

(57) ABSTRACT

An electrical switching device facilitates selectively controlling a residential power feed. The switching device is configured to couple between a residential electrical-energy meter and a residence. The switching device includes at least one conductor bus bar element, a yoke, and a solenoid assembly. The solenoid assembly includes a biasing member and at least one shorting bar coupled to the biasing member. The at least one shorting bar is movable relative to the at least one conductor bus bar element.

### CROSS-REFERENCE TO RELATED APPLICATIONS

This application is a continuation-in-part of U.S. patent application Ser. No. 11/870,971, filed Oct. 11, 2007, which is hereby incorporated by reference in its entirety.

### BACKGROUND OF THE INVENTION

This invention relates generally to electrical switching devices and, more particularly, to electrical switches that are capable of handling current transfers of up to, or greater than, 200 amps.

In North America, consumers coupled to the electric grid are supplied power with a 2-phase/180° supply. As inflation, as well as the cost of power generation has increased, the costs of supplying power to electrical consumers has also increased. Unfortunately for power distribution companies, the number of electrical utility consumers defaulting on their power bills has also increased. Often, the only recourse for a utility company is to shut-off the power to each defaulting consumer. Utility companies also selectively shut off electrical power to consumers, for a variety of other reasons, such as to enable maintenance to be safely performed.

To shut off the power to an electrical utility consumer, often the utility companies are required to dispatch at least one utility person to the site to disconnect that consumer from the electrical distribution grid. To enhance the power control capabilities of utilities, at least some utility revenue meters are equipped with an electrical switching element that works in cooperation with remote access and control capabilities integrated in the meter. Such electrical switching elements are generally placed in series between the meter and the electrical grid.

At least some known switching elements use some form of electromechanical, magnetically-latching, and/or electrically-controlled solenoid to open or close electrical switching contacts. Opening and closing the electrical switching contacts enables the electrical power supplied to the consumer to be selectively disconnected and/or reconnected. For example, U.S. Pat. No. 6,292,075 to Connell et al., describes a two pole contactor that functions with a solenoid plunger actuator to impart a switching force within the switching element.

Within known switching elements, to limit arcing during operation, the switching force must generally be of a sufficient magnitude to enable the electrical contacts to be rapidly closed or opened. However, although at least some known switching elements are described has having a full load current rating of at least 200 amps, it is not uncommon that such switching elements are derated for only being used with current ratings of 150 amps or less. One reason for such derates is that some of the known switching elements may overheat when operated at the full load current rating. Moreover, because of their internal design, at least some known switching elements have limited switching cycles that may limit their useful life.

For example, at least some known switching elements include copper conductor busbars that transmit the current through the device. To increase the manufacturers ability to use the same conductor buss in different switching element designs, and to minimize the number of switching elements used in the construction of remote meter reading systems, the cross-sectional areas of known copper conductor busbars has been decreased until a flexible, conducting hinge is defined within the busbar. In addition, within at least some known switching elements, such conductor busbars are fabricated with a generally long length that includes a plurality of bends formed between the ends of each busbar. As is known, heat rise within such switching elements is directly proportional to the level of current conducted through the switching device. As such, the reduced cross sectional area of such conductor busses may contribute to the overall switch heat rise. Moreover, the inclusion of bends within such busbars may also cause local thermal stresses to develop.

In addition, depending on the design of the solenoid in known switches, the amount of magnetic latching, i.e., the holding force, may limit the use of the switching element. For example, within at least some known switching elements, the holding force generated by the solenoid may not be sufficient to adequately control heat rise within the switching element during use. Depending on the level of heat rise, the accuracy of the associated meter may decrease.

Accordingly, there is a need for an electrical switching device that is capable of handling currents up to, or greater than, 200 amps and operating with improved heat rise characteristics. Moreover, there is a need for an electrical switching device that has improved performance reliability and is of a design that enables the switching device to be used with a plurality of different meters commercially available from a plurality of different manufactures, and with a plurality of different meter components, such as, but not limited to, extension collars and/or sockets defined within the meter.

### BRIEF DESCRIPTION OF THE INVENTION

In one aspect, an electrical switching device is provided for use with an electrical-energy meter. The switching device includes at least one conductor busbar element, a yoke, and a shorting bar assembly coupled to the yoke. The shorting bar assembly includes a biasing member and at least one shorting bar coupled to the biasing member. The at least one shorting bar is movable relative to the at least one conductor bus bar element.

In another aspect, an electrical switching device is provided for use in selectively controlling residential power feed. The switching device is configured to couple between a residential electrical-energy meter and a residence. The switching device includes at least two conductor busbar elements, a yoke including a yoke opening defined therethrough, and a shorting bar assembly. The shorting bar assembly includes a biasing member and at least two shorting bars coupled to the biasing member. The at least two conductor busbar elements and the at least two shorting bars are oriented in a mirrored arrangement on opposite sides of the yoke opening. The at least two shorting bars are biased away from the at least two conductor busbar elements.

### BRIEF DESCRIPTION OF THE DRAWINGS

FIG. 1 is a partial cross-sectional side view of an exemplary electrical switching device electrically coupled to a known utility revenue meter mounted to determine power consumption within a building;

FIG. 2 is a partially exploded perspective schematic view of the electrical switching device shown in FIG. 1;

FIG. 3 is an enlarged perspective view of an exemplary conductor busbar that may be used with the switching device shown in FIGS. 1 and 2;

FIG. 4 is a perspective rear view of an alternative mounting configuration of the electrical switching device shown in FIGS. 1 and 2;

FIG. 5 is a perspective front view of another alternative mounting configuration of the electrical switching device shown in FIGS. 1 and 2;

FIG. 6 is a partially exploded perspective view of an alternative electrical switching device that may be coupled to a known utility revenue meter to determine power consumption within a building;

FIG. 7 is a perspective bottom view of an alternative yoke and shorting bar assembly that may be used with the switching device shown in FIG. 6;

FIG. 8 is a perspective end view of the yoke and shorting bar assembly shown in FIG. 7; and

FIG. 9 is a perspective side view of the shorting assembly shown in FIG. 7.

### DETAILED DESCRIPTION OF THE INVENTION

Described in detail below are exemplary embodiments of electrical switching devices that facilitate the remote control of electrical power. The systems of the present invention also facilitate increasing the flexibility of the manufacturer during the assembly of the switching device and/or utility revenue meter. More specifically, the systems of the present invention provide a means by which power load supplied to a customer can be disconnected via a manual switch operation, and/or may be disconnected via remote control inputs. Advantageously, reconnection of the power feed can be accomplished by the customer at the direction of the utility company.

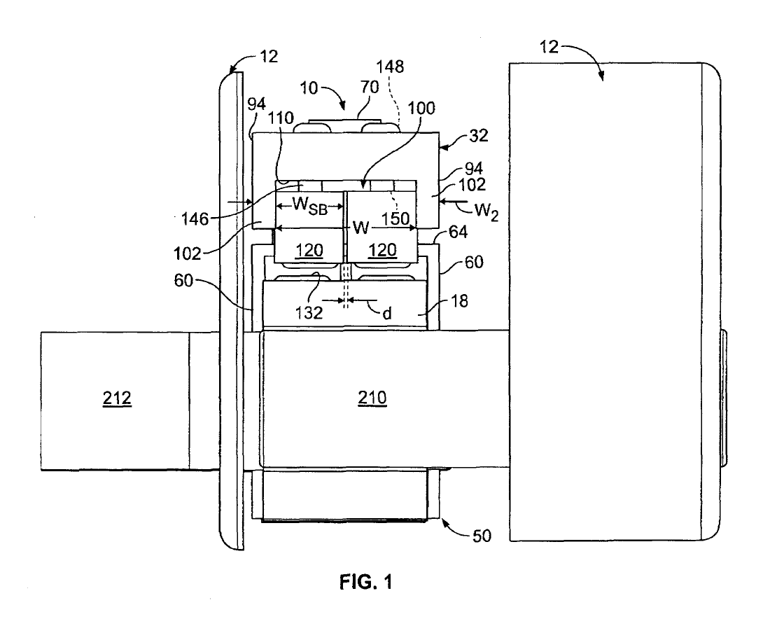

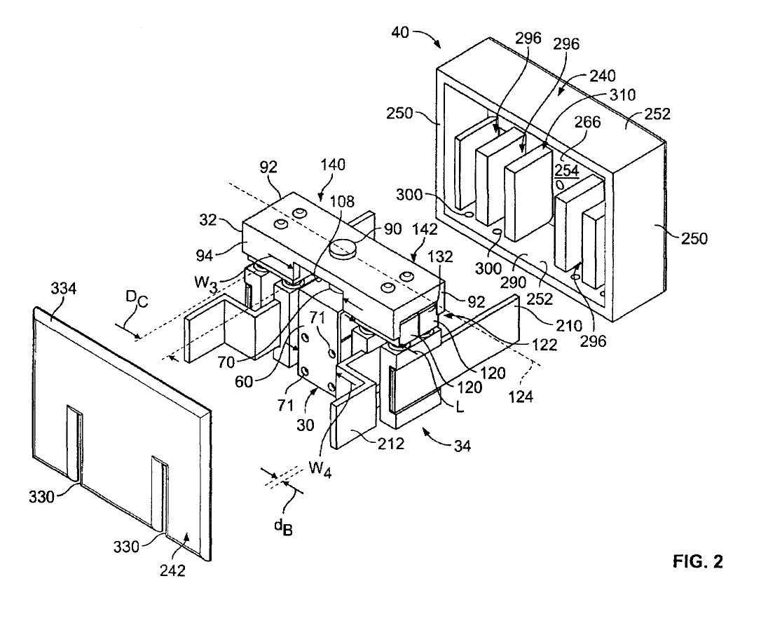

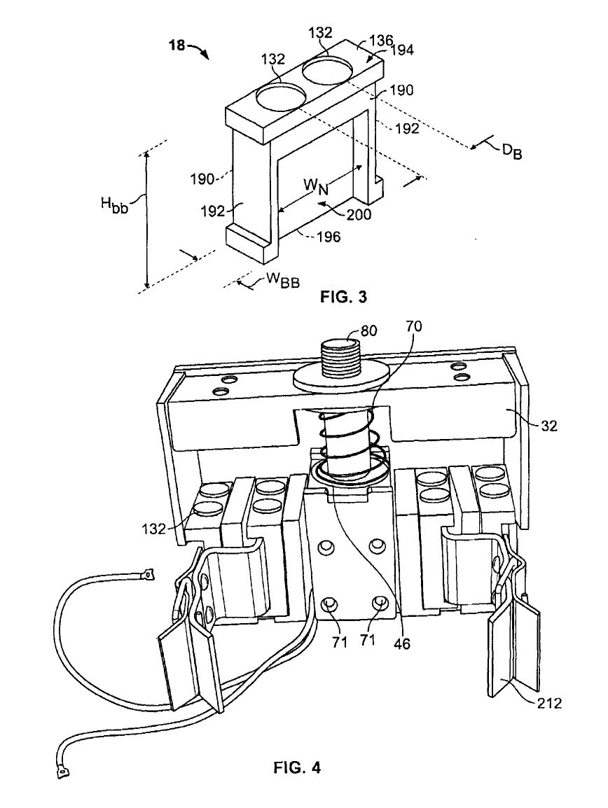

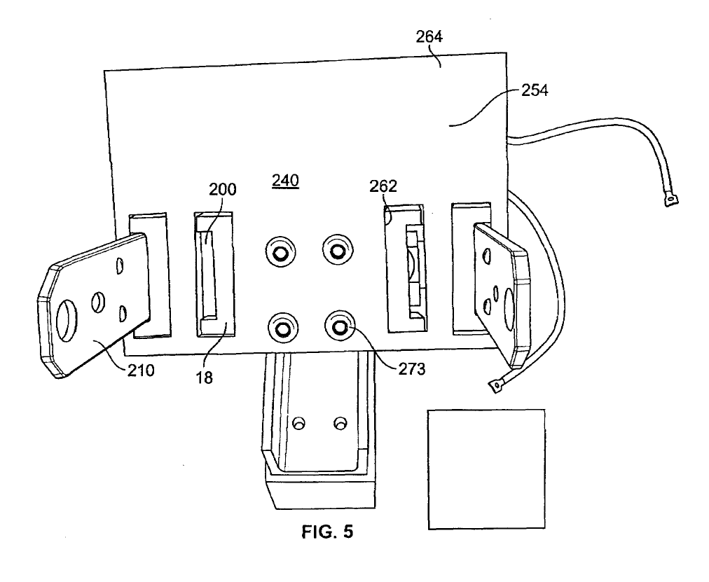

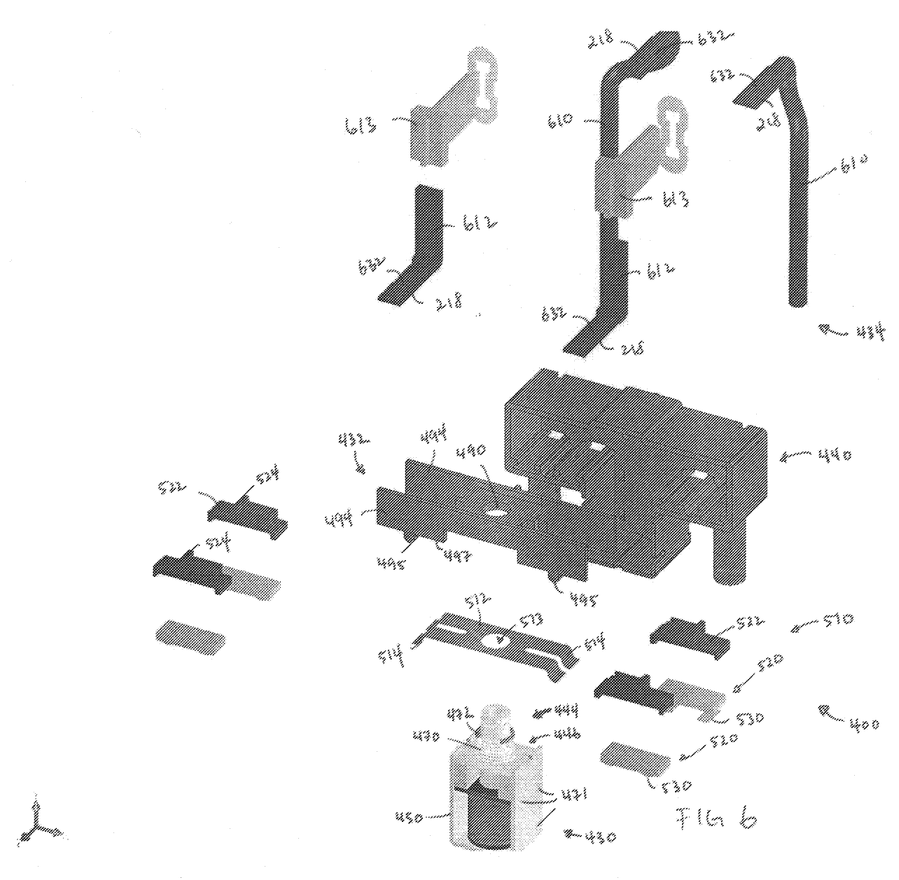

FIG. 1 is a side view of an exemplary electrical switching device or assembly 10 electrically coupled to a known utility revenue meter 12 mounted to determine power consumption within a building (not shown). FIG. 2 is a partially exploded perspective view of electrical switching assembly 10. FIG. 3 is an enlarged perspective view of an exemplary conductor busbar element 18 that may be used with switching assembly 10. FIG. 4 is a perspective rear view of an alternative mounting configuration of electrical switching assembly 10. FIG. 5 is a perspective front view of another alternative mounting configuration of electrical switching assembly 10.

In the exemplary embodiment, electric meter 12 is used to measure electricity usage and to monitor power quality. Moreover, in the exemplary embodiment, meter 12 is a 2-Pole, 4 Jaw revenue meter that may be operable for both single phase and three phase electric power installations. Switching assembly 10 is electrically coupled in series between meter 12 and the residence, and as described in more detail below, enables authorized utility personnel to remotely and/or locally disconnect meter 12, thus isolating the utility power feed to the residence. In the exemplary embodiment, switching assembly 10 is sized to within a socket adapter coupled to meter 12, such as, but not limited to, a Marwell™ E/Z 1000-R4 meter extender adapter, commercially available from Marwell Company, Mentone, Calif. In some embodiments, switching assembly 10 is sized to fit within a recess (not shown) defined in meter 12.

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

In the exemplary embodiment, switch assembly 10 includes a solenoid assembly 30, a yoke 32, and a conductor busbar assembly 34. Moreover, in the exemplary embodiment, switch assembly 10 is housed within a housing 40, as described in more detail below. It should be noted that for simplicity, housing 40 has been removed from FIG. 1. Solenoid assembly 30 includes an electromagnet solenoid, an actuator plunger 44, and at least one magnet 46. In the exemplary embodiment, the electromagnetic solenoid is housed within a solenoid housing or shroud 50 and is coupled to plunger 44. Specifically, in the exemplary embodiment, the solenoid uses a magnetically latching solenoid actuator that is controlled by bi-directional DC voltage, as described in more detail below. Moreover, in the exemplary embodiment, a magnet (not shown), such as, but not limited to, a ferrous magnet, is contained within housing 50.

Solenoid housing 50, in the exemplary embodiment, is generally U-shaped and includes a first pair of opposing side walls 60, and an upper wall 64 that extends substantially perpendicularly between the pair of opposing side walls 60. In an alternative embodiment, housing 50 may have any other shape that enables solenoid assembly 30 to function as described herein. In the exemplary embodiment, housing upper wall 64 is coupled to side walls 60 and is fabricated from a different material than side walls 60. More specifically, in the exemplary embodiment, upper wall 64 is fabricated from, but is not limited to being fabricated from brass. Housing 50, as described in more detail below, facilitates shielding the solenoid and magnet from magnetic fields that may be produced within switch assembly 10.

In the exemplary embodiment, upper wall 64 includes an opening 69 defined therein that extends substantially concentrically through upper wall 64. Opening 69 is sized to receive at least a portion of actuator plunger 44 therethrough. Moreover, and in the exemplary embodiment, each side wall 60 includes a plurality of mounting openings 71 which enable solenoid assembly 30 to be securely coupled in position within housing 40.

Plunger 44, in the exemplary embodiment, is substantially cylindrical and has a substantially circular cross-sectional profile. In the exemplary embodiment, a biasing mechanism 70 circumscribes a portion of plunger 44 to bias yoke 32 away from solenoid assembly 30, as is described in more detail below. More specifically, in the exemplary embodiment, biasing mechanism 70 is a spring. In alternative embodiments, other biasing mechanisms that enable solenoid assembly 30 and switch assembly 10 to function as described herein may be used in place of, or in addition to, spring 70. In one embodiment, plunger 44 is fabricated from a ferrous material and is slidably coupled within the solenoid via a drive coil, for example.

Plunger 44 has a first end (not shown) coupled to the solenoid and a second end 80 that is coupled to yoke 32. More specifically, in the exemplary embodiment, magnet 46 is coupled between biasing mechanism 70 and solenoid assembly upper wall 64. In the exemplary embodiment, magnet 46 is a rare earth magnet. Alternatively, magnet 46 may be any magnet, or combination of magnets that enables solenoid assembly 30 and switch assembly 10 to function as described herein. In another alternative embodiment, solenoid assembly 30 and switch assembly 10 do not include magnet 46. In the exemplary embodiment, plunger second end 80 extends through an opening 90 defined in yoke 32 and is threadably coupled to yoke 32. In the embodiment, a leaf spring (not shown) is also coupled to yoke second end 80 to provide a pre-load to yoke 32.

In the exemplary embodiment, yoke opening 90 is substantially centered within yoke 32 and is sized to receive plunger second end 80 therethrough. Moreover, in the exemplary embodiment, yoke 32 is generally rectangular shaped and includes a first pair of opposing sides 92 that are coupled together via a second pair of opposing sides 94. More specifically, in the exemplary embodiment, sides 94 are each oriented and extend substantially perpendicularly between sides 92. In addition, yoke 32 includes an upper side 96 that is bordered by sides 94 and sides 92.

In the exemplary embodiment, yoke 32 is fabricated from a non-conductive material and is formed with a channel 100 that extends from one side 92 of yoke 32 to the opposite side 92 of yoke 32. Channel 100 has a width W that is narrower than a width W₂ of yoke 32 measured between opposing sides 94. Accordingly, channel 100 is bordered by substantially parallel walls 102 that extend from yoke sides 92 to a solenoid recess 108, and by an inner surface 110 that extends substantially perpendicularly between walls 102. Solenoid recess 108 has a width W₃ that is wider than an outer width W₄ of solenoid walls 60. Accordingly, when yoke 32 is moved towards solenoid housing 50, as described in more detail below, yoke 32 will not contact solenoid housing 50.

Channel width W is sized to receive a pair of side-by-side shorting bars 120 therein. In the exemplary embodiment, shorting bars 120 are identical and each is rectangular shaped. Furthermore, in the exemplary embodiment, shorting bars 120 are each fabricated from a conductive material, such as, but not limited to, copper. Moreover, the length L of each shorting bar 120 enables each bar 120, when coupled to yoke 32 as described in more detail below, to extend from yoke side 92 towards solenoid recess 108, without extending into recess 108. In addition, the width W_{SB} is variably selected to enable a pair of side-by-side shorting bars 120 to be received in channel 100 and to facilitate reducing heat rise in switch assembly 10, as described in more detail below. For example, in the exemplary embodiment, width W_{SB} is between, but is not limited to being, approximately 0.25 inches and 0.375 inches thick.

Shorting bars 120, in the exemplary embodiment, are arranged within yoke 32 in side-by-side pairs 122, wherein the shorting bars 120 within each pair 122 are substantially parallel to each other and are spaced a distance d apart that is substantially constant between the adjacent shorting bars 120. More specifically, in the exemplary embodiment, two pairs 122 are coupled within yoke 32, as described in more detail below. Moreover, each shorting bar 120 within each pair 122 is substantially centered between walls 102 and is oriented substantially parallel to a centerline axis 124 extending through yoke 32. In addition, in the exemplary embodiment, each shorting bar 120 includes a pair of contacts 130 that extend outward from an outer surface 132 of each shorting bar 120 and that are spaced a distance D_{c} apart. More specifically, in the exemplary embodiment, each contact 130 is substantially circular and is oriented, as described in more detail below, to contact a respective mating contact 132 extending outward from an outer surface 136 of a respective conductor busbar element 18.

In the exemplary embodiment, two pairs 122 of shorting bars 120 are coupled within yoke 32 such that each pair 122 is positioned adjacent to an opposite side 92 of yoke 32. Moreover, in the exemplary embodiment, the two pairs 122 of shorting bars 120 are oriented in a mirrored relationship such that plunger 44 is positioned between the adjacent pairs 122 of shorting bars 120. In addition, the two pairs 122 of shorting bars 120 are oriented such that the each bar 120 in a first 140 of the pairs 122 is aligned substantially coaxially with each respective bar 120 in a second 142 of the pairs 122.

Each shorting bar 120 is coupled, in the exemplary embodiment, to yoke 32. More specifically, in the exemplary embodiment, each shorting bar 120 is slidably coupled to yoke 32 via a piston 146. In alternative embodiments, yoke 32 does not include pistons 146 and each shorting bar 120 is free floating independent of any other shorting bar 120. Each piston 146 includes a first end 148 that is securely coupled to yoke 32, and a second end 150 that is slidably coupled to a respective shorting bar 120. Accordingly, during operation, each shorting bar 120 may move or “float” a short distance along piston 146. Moreover, during operation, each bar 120 within each pair 122 of shorting bars 120, may move independently of the other bar 120 within the same pair 122 of shorting bars 120. Specifically, because bars 120 are coupled within yoke 32, shorting bars 120 are moveable with yoke 32 towards and away from conductor busbar elements 18 during operation, as described herein. In addition, regardless of movement of yoke 32, each shorting bar 120 within each pair 122 is moveable independently of every other bar 120 coupled to yoke 32.

Each conductor busbar element 18 is fabricated from a conduct material, such as, but not limited to, copper, and in the exemplary embodiment, conductor busbar elements 18 are each generally rectangular shaped. Furthermore, in the exemplary embodiment, busbar elements 18 are arranged within assembly 34 in side-by-side pairs 180. More specifically, in the exemplary embodiment, the conductor busbar elements 18 within each pair 180 are substantially parallel to each other and are spaced a distance d₁ apart that is substantially constant between the adjacent busbar elements 18. Moreover, in the exemplary embodiment, two pairs 180 of busbar elements 18 are coupled within assembly 34, as described in more detail below. Furthermore, in the exemplary embodiment, each busbar element 18 within each pair 180 is oriented substantially perpendicularly to yoke centerline axis 124. In addition, in the exemplary embodiment, the contacts 132 on each busbar element 18 a distance D_{B} apart. More specifically, in the exemplary embodiment, each contact 132 is substantially circular and is oriented, as described in more detail below, to contact a respective mating contact 130 extending outward from a respective shorting bar 120.

In the exemplary embodiment, two pairs 180 of busbar elements 18 are securely coupled within assembly 34 such that each pair 180 is positioned on an opposite side of solenoid housing 50. Moreover, in the exemplary embodiment, the two pairs 180 of busbar elements 18 are oriented symmetrically on each side of housing 50. Each shorting bar 120 is securely coupled in position such that during operation of switch assembly 10, each busbar element 18 remains stationary, regardless of movement of yoke 32.

In the exemplary embodiment, each conductor busbar element 18 has a generally rectangular shape that is defined by a first pair of opposing sides 190, and a second pair of opposing sides 192 that are each oriented substantially perpendicularly to the first pair of sides 190. Moreover, an upper side 194 and a lower side 196 are each oriented substantially perpendicularly to each pair of sides 190 and 192. Contacts 132 extend outward from upper side 194. Accordingly, each busbar element 18 has a height H_{bb} that is measured between sides 194 and 196, and a width W_{bb} that is measured between sides 190 and 192. The dimensions of each busbar element 18 are variably selected to facilitate operation of switch assembly 10 and to facilitate reducing heat rise in switch assembly 10, as described in more detail below. For example, in the exemplary embodiment, width W_{bb} is between, but is not limited to being, approximately 0.25 inches and 0.375 inches thick.

Each conductor busbar element 18 is formed with a notch 200 along one side 190 or 192. In the exemplary embodiment, each notch 200 is substantially rectangular and either extends from lower side 196 towards upper side 194, as shown in the orientation of FIG. 3, or extends from one side 192 to the other side, along either side 194, as shown in the orientations of FIGS. 1, 2, 4, and 5. Each notch 200 has a width Wₙ sized to receive a load side connector 210 and/or a line side connector 212. In the exemplary embodiment, load connector 210 is a blade, and line side connector 212 is a bi-furcated blade that forms a jaw that is configured to receive a stab or blade therein.

Specifically, each busbar element 18 can be fabricated to accommodate a variety of mounting orientations such that an electrical connector, such as, but not limited to, connectors 210 and/or 212 may extend from each busbar element 18 in any of three different orientations, i.e., a 3:00 orientation, a 6:00 orientation, or a 9:00 orientation. (The 3:00 orientation is illustrated in FIGS. 1, 2, and 5, the 9:00 orientation is illustrated in FIGS. 1, 2, and 4, and the 6:00 orientation is illustrated in FIG. 3). As a result, the busbar elements 18 accommodate a variety of connection angles and connection designs extending from meters and/or buildings, thus increasing the flexibility to utility installers and meter manufacturers, for example.

In addition, the width Wₙ of each notch 200 is also selected to be only slightly larger than the width W_{c} of any connector 210 or 212 received within that notch 200. As a result, when each connector 210 or 212 is coupled within a particular notch 200, that notch 200 facilitates providing structural support to the connection between the connector 210 or 212 and that respective busbar element 18. Furthermore, notches 200 facilitate “Murphy-proofing” switch assembly 10, as the notches 200 orient the connectors 210 and/or 212 relative to busbar assembly 34 and to switch assembly 10.

Within switch assembly 10, each busbar 18 is only securely coupled to only one connector 210 or 212. In one embodiment, a respective connector 210 or 212 is brazed to a respective busbar 18. Alternatively, a connector 210 or 212 may be coupled to a respective busbar using any known coupling means, including, but not limited to, mechanical coupling devices, and/or welding or bonding processes.

Switch assembly 10 is housed within housing 40. Housing 40 is exemplary only, and other housings with different sizes, shapes, and/or configurations may be used. Specifically, in the exemplary embodiment, solenoid assembly 30, yoke 32, and conductor busbar assembly 34 are housed within housing 40. In the exemplary embodiment, housing 40 is a multi-piece assembly that includes a meter-side or front-side portion 240 and a load-side or rear-side portion 242 that are coupled together to define a cavity 244 that is sized to receive switch assembly 10 therein. Moreover, when portions 240 and 242 are coupled together, the overall dimensions of housing 40 are variably selected depending on the application of switch assembly 10 and depending on the meter 12 to which switch assembly 10 is to be coupled to.

In the exemplary embodiment, front-side portion 240 includes a first pair of opposing walls 250 and a second pair of opposing walls 252 that extend substantially perpendicularly between walls 250. A front-side wall 254 extends substantially perpendicularly between walls 250 and walls 252. Accordingly, a portion of cavity 244 is defined by walls 250, 252, and 254. More specifically, when rear-side portion 242 is coupled to front-side portion 240, housing 40 is defined by a four-sided box-like structure, which is generally enclosed on each end, each side, and along its top and bottom. In the exemplary embodiment, walls 250, 252, and 254 are each substantially planar.

Front-side portion 240, in the exemplary embodiment, also includes a plurality of dividers 260 and a plurality of slotted openings 262 that extend from an outer surface 264 of wall 254 to an inner surface 266 of wall 254. More specifically, openings 262 are each shaped with a shape that is substantially similar to, and slightly larger than a cross-sectional shape of each busbar element 18, before any notches 200 are formed in the element 18. Accordingly, in the exemplary embodiment, each opening 262 is generally rectangular-shaped. In addition, openings 262 are oriented such that each busbar element 18 is substantially centered within a respective opening 262, when switch assembly 10 is fully assembled. As a result, openings 262 facilitate the assembly and disassembly of switch assembly 10, as described in more detail below. As such, in the exemplary embodiment, two openings 262 are defined in front-side wall between solenoid housing 50 and housing walls 250.

Housing front-side wall 254 also includes a plurality of mounting openings 270 that extend through wall 254 from outer surface 264 to inner surface 266. Openings 270 are substantially concentrically aligned with shroud housing openings 70 when shroud housing 50 is coupled within housing 40. More specifically, openings 270 enable shroud housing 50 to be securely coupled within housing 40 using any known coupling mechanisms, such as, but not limited to only, threaded fasteners 273.

Dividers 260 are spaced apart between housing walls 250 and each extends upward from an inner surface 290 of a lower housing wall 252. More specifically, each divider 260 extends substantially perpendicularly upward a height H_{d} from inner surface 290 towards the opposite housing wall 252. In the exemplary embodiment, divider height H_{d} is approximately the same as, or slightly taller than, busbar element height H_{bb}. Moreover, because dividers 260 are spaced apart, a plurality of gaps 296 are defined between adjacent pairs of dividers 260. Each gap 296 is sized to receive a respective busbar element 18 therein. Dividers 260 provide structural support to busbar elements 18 secured within gaps 296 and because dividers 260 are fabricated from a non-conductive material, dividers provide insulation between adjacent pairs of busbar elements 18, and between solenoid housing 50 and each adjacent busbar element 18.

In the exemplary embodiment, the lower housing wall 252 also includes a plurality of mounting openings 300 defined therein. Each opening 300 extends from inner surface 290 to an outer surface (not shown) of the lower housing wall 252. Openings 300 enable busbar elements 18 to be securely coupled in position within housing 40. Other openings 300 enable housing 40 to be securely coupled in position within a meter 12, for example. In addition, the lower housing wall 252 also includes at least a pair of slots (not shown) defined therein that accommodate a 6:00 mounting orientation of connectors 210.

Because dividers 260 extend only partially from surface 290 towards the opposite wall 240, a gap 310 is defined between the lower housing wall 252 and the opposite upper housing wall 252. Gap 310 is sized to receive yoke 32 therein and more specifically, is sized to enable yoke 32 to selectively move during operation of switch assembly 10, as described in more detail below.

In the exemplary embodiment, rear-side portion 242 is sized with approximately the same dimensions as front-side wall 254, such that an outer perimeter of portion 242 substantially mates against a perimeter defined by walls 250 and 252. Moreover, in the exemplary embodiment, rear-side portion 242 is substantially planar and includes a pair of slots 330 defined therein. Specifically, in the exemplary embodiment, slots 330 extend from a lower edge 332 of portion 242 towards an upper edge 334 of portion 242. Slots 330 are oriented and sized to enable at least a portion of a connector 210 and/or 212 to extend therethrough when the connector 210 or 212 is securely coupled to a respective busbar element 18.

During assembly of switch assembly 10, in the exemplary embodiment, initially two pairs of shorting bars 120 are each coupled within yoke channel 100 via pistons 146. After all shorting bars 120 are coupled to yoke 32, the shorting bars 120 form a system of free-floating, movable conducting elements that, as described in more detail below, transfer current from the residential meter output (i.e., the line) to the residence (i.e., the load). Because the orientation of the shorting bars is not only mirrored, but is also symmetrical, shorting bars 120 are balanced about actuator plunger 44. As such, during operation, the orientation of shorting bars 120 facilitates yoke 32 providing a substantially consistent force being applied between each set of mating contacts 130 and 132. The length L of shorting bars 120 facilitates reducing heat rise within switch assembly 10. As a result of reduced heat rise, the useful life of switch assembly 10 is facilitated to be extended.

Plunger 44 is slidably coupled to the solenoid via a drive coil, for example, and is then securely coupled to yoke 32. More specifically, the second end 80 of plunger 44 is coupled to yoke 32 such that a leaf spring induces a pre-load into solenoid assembly 30. The pre-load is selected to facilitate ensuring that all eight sets of mating contacts 130 and 132 receive approximately the same contact force during switch assembly 10 operation.

Solenoid assembly 30 is coupled within housing front-side portion 240. As described above, the solenoid and at least one magnet, such as a ferrous magnet or a rare earth magnet, is housed within solenoid shroud 50. In addition, a rare earth magnet 46 is positioned between biasing mechanism 70 and solenoid housing upper wall 64. The magnet 46 facilitates increasing the magnetic holding forces that can be obtained from the magnetically-latching solenoid housed within shroud 50, without modifying the basic solenoid design. As a result, during operation solenoid assembly 30 can produce magnetic holding forces traditionally only available from larger, more expensive solenoid assemblies.

When solenoid housing 50 is positioned within front-side portion 240, mounting openings 71 formed in housing 50 are aligned substantially concentrically with openings 270 formed in front-side wall 254. In the exemplary embodiment, a plurality of fasteners 273 are then used to secure housing 50 within front-side portion 240. In addition, when housing 50 is positioned within portion 240, yoke 32 is positioned within front-side portion gap 310.

Two line side connectors 212 are then securely coupled to two busbar elements 18 such that at least a portion of each connector 212 is received in the notch 200 defined on each element 18. More specifically, the tight fit defined between each connector 212 and each respective notch 200 enhances the structural integrity of busbar assembly 34 and facilitates reducing and/or eliminating movement of connectors 212 within switch assembly 10 if switch assembly 10 is exposed to shock and/or vibration, or excess current forces. The two busbar elements 18, and their associated connectors 212, are then inserted within a respective gap 296 defined within front-side portion 240 such that connectors 212 extend outward from switch assembly 30 in a desired one of three mounting orientations described above. More specifically, in the exemplary embodiment, the two busbar elements 18, and their associated connectors 212, are inserted into the gaps 296 defined adjacent to solenoid housing 50. The two busbar elements 18 are then secured in position using threaded fasteners 273 extending through openings 300.

In one embodiment, two load-side connectors 210 are then each securely coupled to a respective busbar element 18 such that at least a portion of each connector 210 is received in the notch 200 defined on each element 18. More specifically, the tight fit defined between each connector 212 and each respective notch 200 enhances the structural integrity of busbar assembly 34 and facilitates reducing and/or eliminating movement of connectors 210 within switch assembly 10 if switch assembly 10 is exposed to shock and/or vibration, or excess current forces. The two busbar elements 18, and their associated connectors 210, are then inserted within a respective gap 296 defined within front-side portion 240. More specifically, in the exemplary embodiment, the two busbar elements 18, and their associated connectors 212, are inserted into the gaps 296 defined adjacent housing outer walls 250. The two busbar elements 18 are then secured in position using fasteners 273 extending through openings 300.

Alternatively, the two load-side connectors 210 may be coupled initially to the connectors (not shown) within meter 12. More specifically, because busbar elements 18 may be coupled within housing 40 from the rear-side of housing 40 before rear-side portion 242 is coupled to front-side portion 240, or may be slidably inserted and coupled into housing 40 through front-side portion openings 262, meter and meter collar manufacturers may pre-assemble the connectors 210 to their products prior to final assembly of switching assembly 10. For example, in one embodiment, switch assembly 10 may be bonded or coupled against an internal meter busing (not shown) within meter 12, rather than being coupled within a meter extension collar.

In either embodiment, rear-side portion 242 is coupled to front-side portion 240 and switching assembly 10 is electrically coupled to meter 12. More specifically, the slots 330 defined in rear-side portion 242 enable rear side portion 242 to be coupled to front-side portion 240 while connectors 212 extend outward from busbar elements 18. As a result, switching assembly 10, and more specifically, the rigid busbar assembly 34 created, accommodates a plurality of connection orientations. The various connection orientations facilitate simplifying the coupling and integration of switch assembly 10 between different types of meters, meter collars, and meter sockets. More generally, the construction of switching assembly 10 may easily be varied to facilitate optimizing the ease of integration into a plurality of varied platforms.

Regardless of the connection orientation used, switch assembly 10, the design of busbar elements 18 and shorting bars 120 ensures that contacts 130 and 132 mate during operation of switch assembly 10. As a result, when switch assembly 10 is fully assembled, two circuits are defined within switch assembly 10 between elements 18 and bars 120. Moreover, the design of busbar elements 18 and shorting bars 120 facilitates switch assembly 10 incorporating copper conductors that have a significantly larger cross-sectional area and a reduced conductor length within switch assembly 10 than in known switching devices. In addition, the design of busbar elements 18 and bars 120 facilitates reducing the number of switching elements used in the construction of such a switching device. As such, elements 18 and bars 120 facilitate reducing heat rise as compared to known switching devices operating with comparable current levels.

During operation, an appropriate DC voltage is supplied to solenoid assembly 30 to induce movement of solenoid plunger 44. Specifically, in the exemplary embodiment, the solenoid uses a magnetically latching solenoid actuator that is controlled by bi-directional DC voltage. As a result, only a short DC voltage pulse is necessary of its operating and release functions. As the DC voltage is initially supplied to the solenoid assembly 30, solenoid plunger 44 is shifted downward to move yoke 32 from an open position, in which shorting bars 120 are spaced a distance above busbar assembly 34, to a closed or latched position in which shorting bars 120 are positioned in contact with busbar elements 18. Specifically, when yoke 32 is latched in position against busbar assembly 34, shorting bar contacts 130 are positioned in electrical contact against busbar element contacts 132.

The solenoid plunger 44 is latched in position by the magnet contained in the solenoid housing 50 and by the rare earth magnet 46 positioned between biasing mechanism 70 and solenoid housing upper wall 64. Magnet 46 facilitates increasing the magnetic holding forces. The enhanced magnet force facilitates operating the switch assembly with a rated device current level of at least 200 Amps or greater, with a minimum heat rise across the switched electrical contacts 130 and 132. Moreover, the enhanced magnetic force induced by magnet 46 facilitates switching assembly 10 opening or closing contacts 130 and 132 rapidly enough to limit arcing between contacts 130 and 132. Because shorting bars 120 are “free floating” the force induced to contacts 132 from contacts 130 should be approximately the same across all pairs of mating contacts 130 and 132 within switch assembly 10.

When solenoid plunger 44 is latched in the closed position, current is supplied to the residence. When another appropriate DC voltage is supplied to solenoid assembly 30, solenoid plunger 44 is selectively moved to the open position, and because each of the two circuits defined within switch assembly 10 are opened, current is no longer supplied to the residence. When DC voltage is removed, yoke 32 is biased by biasing mechanism 70 to remain in the open position.

Switch assembly 10 can be disconnected and/or reconnected locally or remotely. Manual disconnection/reconnect can be accomplished by removing an access cover (not shown) secured to the utility meter 12 and selectively operating a toggle switch (not shown) contained therein. In the exemplary embodiment, LED lights (not shown) are also included to indicate when switch assembly 10 is in the closed position and customer power is connected. In one embodiment, switch assembly 10 is coupled to an IPS controller module that enables remote control of switch assembly 10.

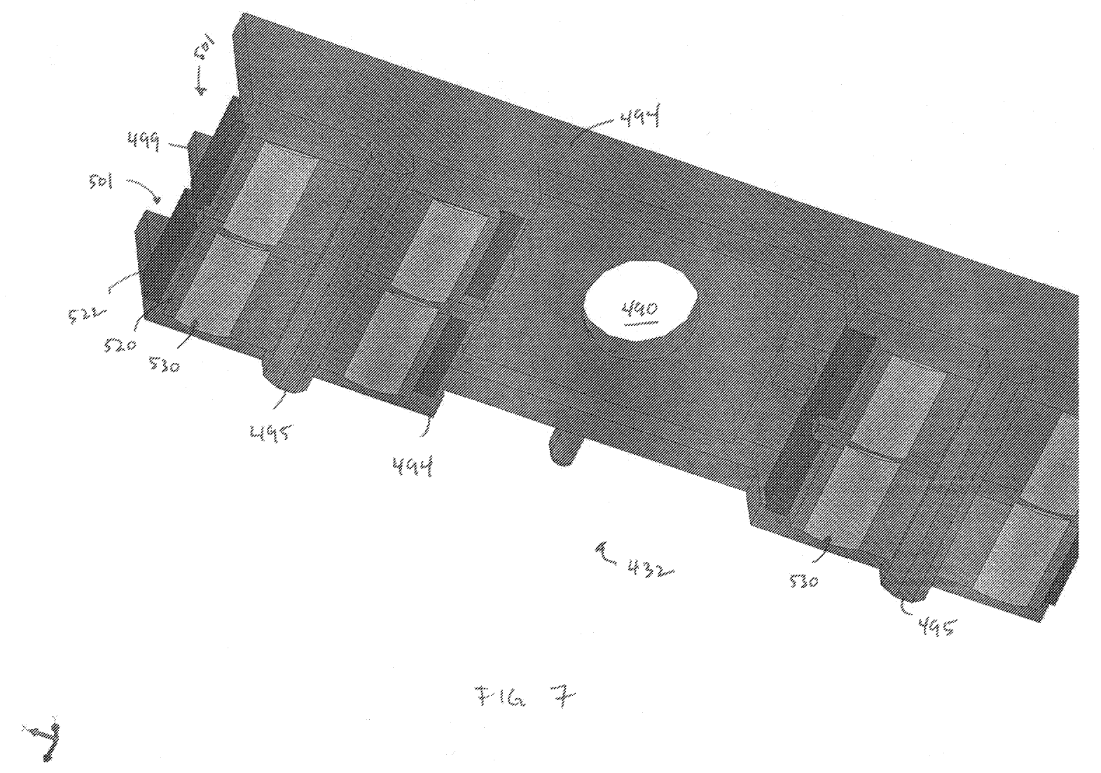

FIG. 6 is a partially exploded view an alternative electrical switching device or assembly 400 electrically coupleable to utility revenue meter 12 (shown in FIG. 1) to determine power consumption within a building (not shown). In the exemplary embodiment, switch assembly 400 includes a solenoid assembly 430, a yoke 432, and a conductor busbar assembly 434. In the exemplary embodiment, switch assembly 400 is housed within a housing 440.

In the exemplary embodiment, solenoid assembly 430 includes an electromagnet solenoid, an actuator plunger 444, and at least one magnet 446. In the exemplary embodiment, the electromagnetic solenoid is housed within a solenoid housing or shroud 450 and is coupled to plunger 444. In the exemplary embodiment, solenoid housing 450 includes a plurality of mounting openings 471 that enable solenoid assembly 430 to be securely coupled in position within housing 440. Notably, solenoid assembly 430 may be mounted in any suitable orientation with respect to housing 440, such that solenoid assembly 430 is securely coupled in position within housing 440. For example, in the exemplary embodiment, solenoid housing 450 is rotated 90° about a longitudinal axis of plunger 444 as compared to the relative orientation of solenoid housing 450 and housing 440.

Plunger 444, in the exemplary embodiment, is substantially cylindrical and has a substantially circular cross-sectional profile. In the exemplary embodiment, a biasing mechanism 470 circumscribes a portion of plunger 444 to facilitate biasing yoke 432 away from solenoid assembly 430. In the exemplary embodiment biasing mechanism 470 is a spring having a conical body that facilitates retaining biasing mechanism 470 between yoke 432 and solenoid assembly 430. In the exemplary embodiment, a diameter of spring 470 may be varied to adjust a spring force that enables holding switch assembly 10 in an open position while allowing switch assembly 10 to be moved to a closed position. Moreover, in the exemplary embodiment, a retaining mechanism 472 circumscribes a portion of plunger 444 to facilitate retaining yoke 432, plunger 444, and/or a biasing member, described in further detail below, in relative position. In one embodiment, a first retaining mechanism 472 is positioned above yoke 432 and a retaining mechanism 472 is positioned below the biasing member. In the exemplary embodiment, retaining mechanism 472 is a C-ring. In alternative embodiments, any retaining mechanism that enables solenoid assembly 430 and switch assembly 400 to function as described herein may be used in place of, or in addition to, C-ring 472.

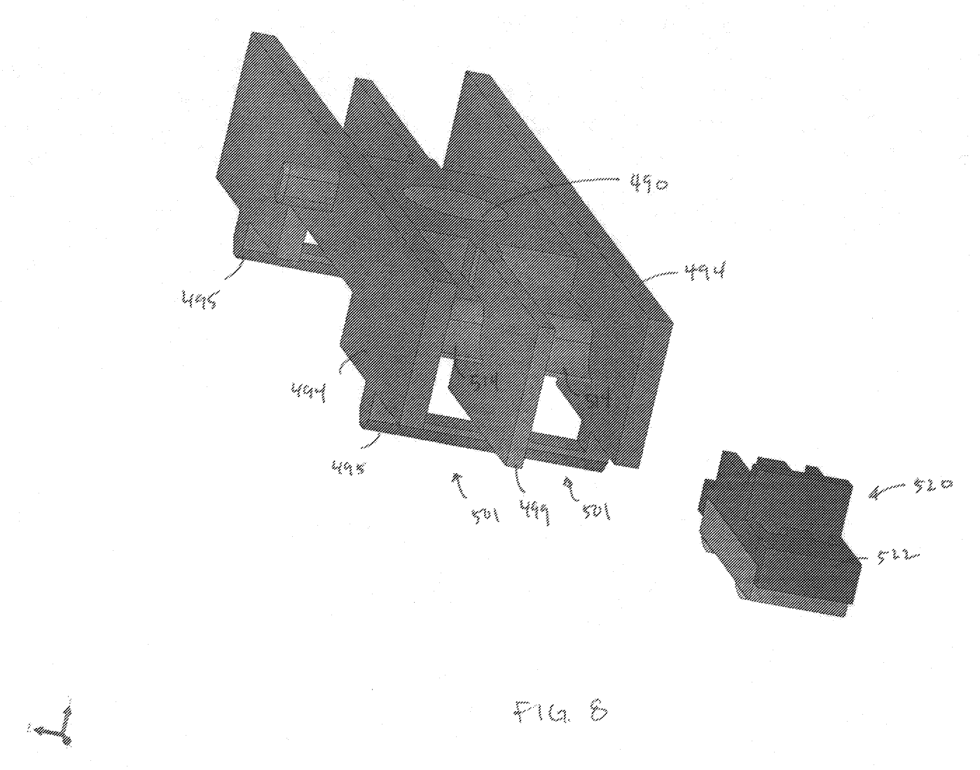

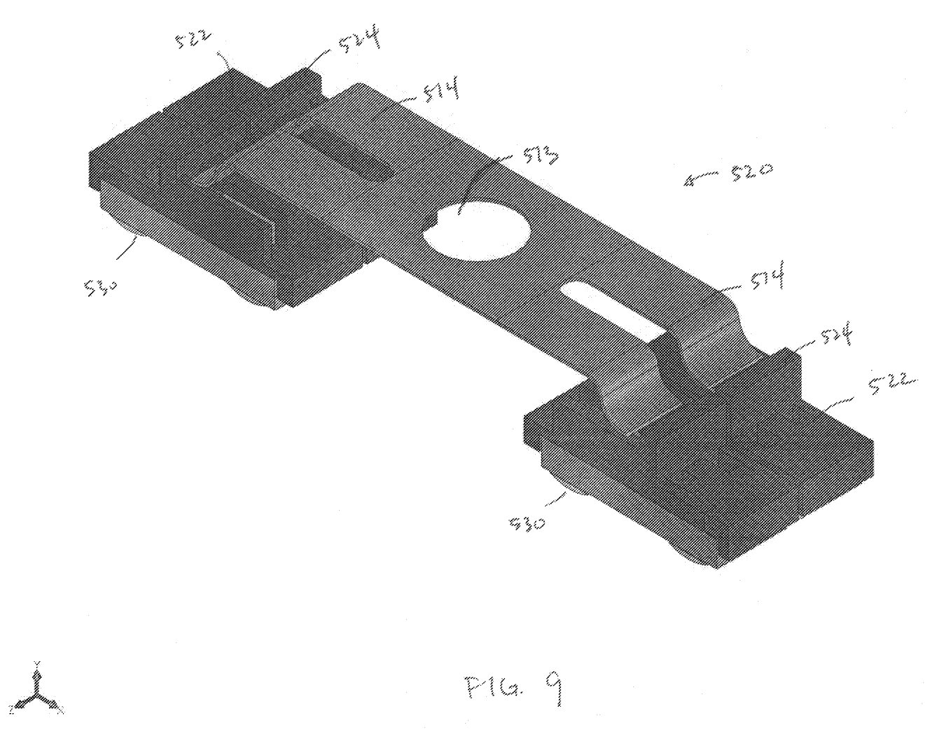

FIGS. 7 and 8 are perspective views of yoke 432. In the exemplary embodiment, yoke 432 includes an opening 490 that is substantially centered within yoke 432 and that is sized to receive plunger 444 therethrough. In the exemplary embodiment, yoke 432 is generally rectangular shaped and includes a pair of opposing sides 494 and a pair of crossbars 495 that are substantially perpendicular to sides 494 and that extend along a bottom side 497 of yoke 432.

In the exemplary embodiment, a dividing wall 499 (shown in FIG. 7) extends between opposing sides 494 of yoke opening 490. In the exemplary embodiment, each dividing wall 499 is substantially parallel to opposing sides 494 to form a pair of channels 501 (shown in FIG. 7), respectively, that extend between dividing wall 499 and each opposing side 494. In the exemplary embodiment, each channel 501 is sized to receive a shorting bar 520, described in more detail below, therein.

As shown in FIGS. 7 and 8, yoke 432 is coupled to a shorting assembly 510. FIG. 9 is a perspective side view of shorting assembly 510. In the exemplary embodiment, shorting assembly 510 includes a biasing member 512 coupled to at least one shorting bar 520. In the exemplary embodiment, biasing member 512 is formed within an opening 513 that is substantially centered within biasing member 512 and that is sized to receive plunger 444 therethrough. Moreover, biasing member 512 includes at least one leaf spring 514 that is arcuate and that has a rectangular cross sectional profile that enables shorting bar 520 to be moved relative to a busbar element 218, described in more detail below. In the exemplary embodiment, an end of each leaf spring 514 is curved and provides a pivot point for shorting bar 520, such that shorting bar 520 is configured to rotate and/or adjust to compensate for potential misalignment relative to busbar element 218.

In the exemplary embodiment, leaf springs 514 are sized and oriented to fit within channels 501. As such, in the exemplary embodiment, shorting bars 520 are arranged within yoke 432 in side-by-side pairs, wherein each pair of shorting bars 520 are substantially parallel to each other and are spaced apart by dividing wall 499. More specifically, in the exemplary embodiment, shorting bars 520 are positioned in a mirrored relationship such that yoke opening 490 is positioned between the pairs of shorting bars 520. Moreover, in the exemplary embodiment, each shorting bar 520 is substantially centered between each respective side 494 and dividing wall 442, and each shorting bar 520 is oriented substantially parallel to side 494 and/or to dividing wall 442. Moreover, in the exemplary embodiment, each shorting bar 520 is positioned within yoke 432 to be substantially aligned with respective busbar element 218 during operation of switch assembly 400. In the closed position, shorting bars 520 are held against stationary busbar elements 218 with a force that is applied by leaf springs 514.

In the exemplary embodiment, biasing member 512 enables each shorting bar 520 to move independently of other shorting bars 520 within a respective channel 501. In the exemplary embodiment, biasing member 512 facilitates retaining a shoe 522 and/or shorting bar 520 within channel 501 using a pressure and/or a friction fit. More specifically, in the exemplary embodiment, biasing member 512 biases shoe 522 and/or shorting bar 520 downwardly, such that shoe 522 and/or shorting bar 520 is “pinched” between biasing leaf spring 514 and crossbar 495. As such, in the exemplary embodiment, crossbar 495 facilitates retaining shoe 522 and/or shorting bar 520 within channel 501.

In the exemplary embodiment, shoe 522 has a thickness that enables shoe 522 to bias leaf spring 514 when switch assembly 400 is assembled such that a pre-load is induced to shorting bar 520. For example, at least the pre-loaded force of biasing member 512 facilitates holding the movable and fixed contacts together in the closed position. Varying the thickness of shoe 522 may adjust the pre-laded force and may also affect biasing mechanism 470 and/or other solenoid force requirements due to a change in the mass of shorting assembly 510.

In the exemplary embodiment, shoe 522 includes an insulated actuator 524 that is configured to provide a contact status indicating at least one of an open position and/or a closed position. In the exemplary embodiment, actuator 524 provides a handle that is suitable for a user to couple and/or decouple shorting bar 520 to and/or from biasing member 512. In the exemplary embodiment, shorting bar 520 is coupled to a respective shoe 522 in a snap-fit configuration. In alternative embodiments, any other coupling mechanism that enables shorting bar 520 to function as described herein may be used in place of, or in addition to, the snap-fit configuration. Moreover, in the exemplary embodiment, actuator 524 provides a stop for leaf spring 514, such that a horizontal movement of leaf spring 514 beyond actuator 524 is prevented.

In the exemplary embodiment, shorting bars 520 are identical and each is rectangular shaped. Moreover, in the exemplary embodiment, shorting bars 520 are each fabricated from a conductive material, such as, but not limited to, copper. Furthermore, in the exemplary embodiment, each shorting bar 520 includes a pair of contacts 530 that extend outward from shorting bar 520. In the exemplary embodiment, shorting bar 520 is positionable in a cantilevered position across crossbar 495, such that contacts 530 extend along opposite sides of crossbar 495. In the exemplary embodiment, each contact 530 is configured and is \oriented to contact a respective mating contact 632 of respective busbar element 218. More specifically, in the exemplary embodiment, each contact 530 is substantially semi-cylindrical and has a longitudinal axis that extends substantially perpendicular to sides 494.

In the exemplary embodiment, conductor busbar assembly 434 includes at least one busbar element 218 that is generally rectangular and that is sized to fit within housing 440. In the exemplary embodiment, each busbar element 218 includes at least one contact 632. In the exemplary embodiment, each busbar element 218 is coupled to a load side connector 610 and/or to a line side connector 612. In the exemplary embodiment, load side connector 610 has an elongated body, and line side connector 612 has a generally rectangular body that is sized and/or oriented to be coupled to a meter connector blade 613.

During operation, yoke 432 enables shorting bars 520 to be moved towards and away from busbar elements 218, as described herein. In the exemplary embodiment, each shorting bar 520 independently moves or “floats” atop crossbar 495 within yoke 432. More specifically, in the exemplary embodiment, biasing member 512 biases shorting bar 520 toward an equilibrium position, such that when yoke 432 is positioned to couple shorting bar contact 530 to busbar contact 632, busbar element 218 forces shorting bar 520 upward within yoke 432 while biasing member 512 biases shorting bar downward. Moreover, in the exemplary embodiment, shorting bar 520 may be oriented relative to crossbar 495 such that shorting bar contacts 530 are suitably positioned relative to busbar contacts 632.

For example, for the open position, the solenoid winding provides a positively-pulsed, electromotive force (EMF) suitable to counter a static force of the permanent magnets that, while compressing the biasing mechanism 470 and/or biasing member 512, is holding plunger 444 in the retracted position. When a suitable EMF is induced in the solenoid winding, plunger 444, with the aid of biasing mechanism 470 and/or biasing member 512, moves away from the concentrated force of the closed position. It should be noted that even in the fully open, extended position, there is still a force from the permanent magnets attempting to pull the extended plunger 444 back to the retracted position. This force is overcome by the force of the extended, biasing mechanism 470. Moreover, for the closed position, the solenoid winding provides a negatively-pulsed, EMF, while being aided by the permanent magnets, to counter the static force of biasing mechanism 470 and/or biasing member 512 and, thus, return plunger 444 to the retracted position.

Exemplary embodiments of a remote controlled/locally controlled switching assembly are described above in detail. Operation of the switching assembly described herein relies on the interaction between the moveable contact assembly (i.e., yoke and shorting assembly) and the magnetic latching solenoid (i.e., solenoid assembly). This interaction requires a balance between the static force that holds the moveable contacts against the stationary bus contacts while in the closed position and the opposing force required to life and hold the moveable contact assembly away from the stationary bus when the relay is opening and/or in the final open position. For example, in the closed position, the solenoid must have sufficiently strong permanent magnets to overcome the combined forces of the leaf spring and/or the conical spring on the solenoid shaft. Moreover, in the open position, the conical spring must be sufficiently strong to overcome the pull on the solenoid shaft that is working to retract the solenoid.

Although the methods and systems described herein are herein described and illustrated in association with a residential electric meter, it should be understood that the present invention may be used with any other electrical systems. More specifically, the switching assembly described herein is not limited to only being used with the architecture, components, or with the specific embodiments described herein, but rather, aspects of the switching assembly and/or the method of controlling power to a consumer may be utilized independently and separately from other switching assemblies and other power control methods.

Moreover, based on the foregoing information, it is readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to its exemplary embodiment, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof. Although specific terms are employed herein, they are used in a general and descriptive sense on and not for the purpose of limitation.

While the invention has been described in terms of various specific embodiments, those skilled in the art will recognize that the invention can be practiced with modification within the spirit and scope of the claims.

What is claimed is:

1. An electrical switching device for use with an electrical-energy meter, said switching device comprising:
at least one conductor busbar element;
a yoke; and
a shorting bar assembly coupled to said yoke, said shorting bar assembly comprising a biasing member and at least one shorting bar coupled to said biasing member, such that said at least one shorting bar is movable relative to said at least one conductor busbar element.

2. An electrical switching device for use in selectively controlling residential power feed, said switching device configured to couple between a residential electrical-energy meter and a residence, said switching device comprising:
at least two conductor busbar elements,
a yoke comprising a yoke opening defined therethrough; and
a shorting bar assembly comprising a biasing member and at least two shorting bars coupled to said biasing member, such that said at least two conductor busbar elements and said at least two shorting bars are oriented in a mirrored arrangement on opposite sides of said yoke opening, said at least two shorting bars biased away from said at least two conductor busbar elements.
